(19) United States
(12) Patent Application Publication
(10) Pub. No.: US 2011/0157288 A1
(43) Pub. Date: Jun. 30, 2011

(54) RECORDING APPARATUS AND LINE TYPE LIQUID DISCHARGE RECORDING APPARATUS

(76) Inventors: Toshiyasu MORIMOTO, Kanagawa (JP); Hitoshi Kamoda, Kanagawa (JP)

(21) Appl. No.: 12/976,318

(22) Filed: Dec. 22, 2010

(30) Foreign Application Priority Data
Dec. 28, 2009 (JP) P2009-298740

(51) Int. Cl. B41J 2/01

(52) U.S. Cl. 347/104

(57) ABSTRACT

A recording apparatus includes a recording head performing recording onto a recording sheet; a platen section guiding the recording sheet to a position facing the recording head; a suction unit which includes a plurality of suction openings provided at the platen section and sucks and holds the recording sheet, a suction duct provided facing the suction openings, and a suction fan connected to the suction duct, and sucks and holds the recording sheet on the platen section through the suction openings; and a shutter mechanism which opens and closes the suction duct, wherein the shutter mechanism includes a shutter sheet in which at least one exposure opening portion exposing the suction duct is formed corresponding to the width of the recording sheet, and a shutter sheet movement mechanism which makes the shutter sheet travel between the suction duct and a back surface of the platen section.

### BACKGROUND OF THE INVENTION

1. Field of the Invention

The present invention relates to a recording apparatus and a line type liquid discharge recording apparatus which are provided with a suction unit for keeping the distance between a recording sheet on a platen section and a recording head constant.

2. Description of the Related Art

In an ink jet recording apparatus, keeping the distance between a recording sheet on a platen and a recording head constant is an important task for performing correct impact of ink. For this reason, at the ink jet recording apparatus, a suction section which sucks the recording sheet onto an upper surface of the platen is often provided. The suction section is usually constituted by a plurality of suction openings formed in a surface of the platen and a fan which sucks external air from each suction opening.

In such a configuration in which a plurality of suction openings is provided in order to suck the recording sheet onto the surface of the platen, there is a problem in which suction capability is lowered when a leading end of the recording sheet passes over the platen. When the leading end of the recording sheet passes over the platen, a plurality of suction openings disposed in a transport direction (a sub-scanning direction) is covered by the leading end of the recording sheet in order from the suction opening on the upstream side in the transport direction among the suction openings. That is, while the leading end of the recording sheet is transported, a suction operation is performed in a state where the suction openings close to the paper discharge side are not yet covered by the recording sheet. For this reason, compared to a state where all the suction openings are covered by the recording sheet, negative pressure of the suction openings does not sufficiently rise due to air leakage, so that suction capability is lowered. In such a case, it is difficult to properly keep the distance between the recording head and the recording sheet. For example, in such a case, it is difficult to correct a curl state occurring on the leading end side of the recording sheet. In addition, problems occur such as an increase in noise due to generation of a sound by passage of external air through the suction openings which are not covered by the recording sheet, and lowering of impact precision due to disturbance of discharge of ink by an air current of the suction opening.

In order to solve the problems as described above, in Japanese Unexamined Patent Application Publication No. 2007-152762, a configuration is described in which a plurality of shielding plates which blocks and opens suction openings is provided in the transport direction of the recording sheet and a mechanism is provided which sequentially opens or blocks the suction openings according to movement of a leading end and a back end of the recording sheet.

On the other hand, there is an ink jet printer which can cope with down to the minimum paper width of A4 (210 mm), for example, even in a case where the maximum paper width is a B0 (1030 mm), and perform recording in many types of paper widths between the maximum paper width and the minimum paper width. In such an ink jet printer, when recording is performed on the recording sheet of a width smaller than the maximum paper width, in the suction openings which are not covered by the recording sheet, air is leaked. For this reason, in Japanese Unexamined Patent Application Publication No. 2007-152762, a problem occurs which is similar to the above-described case where the suction openings of a leading end portion of the recording sheet are not blocked.

In Japanese Unexamined Patent Application Publication No. 2004-098319 and Japanese Unexamined Patent Application Publication No. 2007-223139, a shutter is described which corresponds to a plurality of recording sheet widths as well as the transport direction of the recording sheet.

In Japanese Unexamined Patent Application Publication No. 2004-098319, a suction opening on a platen is disposed in a plurality in a linear fashion having inclinations with respect to a main scanning direction and a sub-scanning direction, and a plurality of shutters for blocking the suction openings reciprocates in the main scanning direction, thereby interlocking open and closed states of the suction openings with movement of a leading end and a back end of the recording sheet. Also, in Japanese Unexamined Patent Application Publication No. 2004-098319, with respect to a small paper width, a plurality of shutters is divided into several groups and a shielding plate movement mechanism is provided for each group, thereby individually moving the respective groups.

However, in Japanese Unexamined Patent Application Publication No. 2004-098319, as many shielding plate movement mechanisms as the varieties of widths of the recording sheets are necessary, thereby leading to an increase in the cost of a recording apparatus or an increase in the size of the recording apparatus.

Also, in Japanese Unexamined Patent Application Publication No. 2007-223139, a suction opening of a platen is disposed in a plurality in a linear fashion in a main scanning direction and a sub-scanning direction, and a cylindrical shutter having opened holes is rotated, thereby interlocking open and closed states of the suction openings with movement of a leading end and a back end of the recording sheet. With respect to a small paper width, a countermeasure is made by providing a plurality of holes having a plurality of opening widths at the cylinder. Accordingly, in Japanese Unexamined Patent Application Publication No. 2007-223139, only by a rotation mechanism of the cylindrical shutter, control of opening and closing of the suction openings in the transport direction and the width direction of the recording sheet is performed according to transportation of the recording sheet and the size of the recording sheet.

However, in Japanese Unexamined Patent Application Publication No. 2007-223139, in order to provide openings corresponding to a number of paper widths, the diameter of the cylindrical shutter is increased according to the number of paper widths. For this reason, in Japanese Unexamined Patent Application Publication No. 2007-223139, in the case of coping with a number of paper widths, an increase in size of the recording apparatus is inevitable.

### SUMMARY OF THE INVENTION

In view of the problems as described above, it is desirable to provide a recording apparatus and a line type liquid discharge recording apparatus, which can prevent lowering of suction power for a recording sheet.

According to an embodiment of the present invention, there is provided a recording apparatus including: a recording head which performs recording onto a recording sheet on the basis of image information; a platen section which guides the recording sheet to a position facing the recording head; a suction unit which includes a plurality of suction openings which is provided at the platen section and sucks and holds the recording sheet, a suction duct which is provided facing the plurality of suction openings, and a suction fan which is connected to the suction duct, and sucks and holds the recording sheet on the platen section through the suction openings; and a shutter mechanism which opens and closes the suction duct.

The shutter mechanism includes a shutter sheet in which at least one exposure opening portion which corresponds to the suction duct and exposes the suction duct is formed corresponding to a width of the recording sheet, and a shutter sheet movement mechanism which makes the shutter sheet travel between the suction duct and a back surface of the platen section.

In the shutter mechanism, when the recording sheet is transported over the platen section, the exposure opening portion of the shutter sheet sequentially opens the suction duct and the suction openings according to a position of a leading end of the recording sheet and the exposure opening portion of the shutter sheet sequentially closes the suction duct and the suction openings according to a position of a back end of the recording sheet.

According to another embodiment of the present invention, there is provided a line type liquid discharge recording apparatus including: a line type liquid droplet discharge head in which nozzles discharging given liquid as liquid droplets are formed over approximately the maximum width of a recording sheet; a platen section which guides the recording sheet to a position facing the line type liquid droplet discharge head; a suction unit which includes a plurality of suction openings which is provided at the platen section and sucks and holds the recording sheet, a suction duct which is provided facing the plurality of suction openings, and a suction fan which is connected to the suction duct, and sucks and holds the recording sheet on the platen section through the suction openings; and a shutter mechanism which opens and closes the suction openings.

The shutter mechanism includes a shutter sheet in which least one exposure opening portion which corresponds to the suction duct and exposes the suction duct is formed corresponding to a width of the recording sheet, and a shutter sheet movement mechanism which makes the shutter sheet travel between the suction duct and a back surface of the platen section.

In the shutter mechanism, when the recording sheet is transported over the platen section, the exposure opening portion of the shutter sheet sequentially opens the suction duct and the suction openings according to a position of a leading end of the recording sheet and the exposure opening portion of the shutter sheet sequentially closes the suction duct and the suction openings according to a position of a back end of the recording sheet.

According to the invention, when the recording sheet is transported over the platen section, the exposure opening portion of the shutter sheet sequentially opens the suction duct and the suction openings according to the position of the leading end of the recording sheet. Also, the exposure opening portion of the shutter sheet sequentially closes the suction duct and the suction openings according to the position of the back end of the recording sheet. Therefore, it is possible to prevent lowering of suction capability at the leading end and the back end of the recording sheet in a simple configuration.

Also, also in the width direction of the recording sheet, by removing suction from the suction openings which are not covered by the recording sheet, it is possible to prevent lowering of suction capability. In addition, it is possible to obtain effects such as suppression of discharge disturbance of ink by an air current which is generated from the suction opening, prevention of a noise caused by the air current, and prevention of drying of nozzle orifices by the air current.

Also, in the invention, also in a case where there are various sizes in the width direction of the recording sheets, it is possible to obtain the above-mentioned effects without necessitating a large space.

Also, in the invention, a recording sheet suction function, an idle discharge receiving function, a capping function, a moisturizing liquid supply function, and an ink mist collection function are provided together in the platen section. Therefore, in the invention, compared to a case where the respective functions are realized by separate components or mechanisms, a reduction in cost by a reduction in the number of components or an improvement in reliability by simplification of a mechanism becomes possible.

### BRIEF DESCRIPTION OF THE DRAWINGS

FIG. 1 is a schematic cross-sectional view of a line type ink jet printer apparatus to which the invention is applied.

FIG. 2 is a vertical cross-sectional view of a platen section, a suction unit, and a shutter mechanism.

FIG. 3 is a perspective view of the platen section, the suction unit, and the shutter mechanism.

FIG. 4 is a perspective view showing a state where a platen plate has been removed from the perspective view of FIG. 3 (the right side) and a state where the platen plate and an absorber have been removed from the perspective view of FIG. 3 (the left side).

FIG. 5 is a drawing showing a line head of a recording section viewed from the platen section side.

FIG. 6 is a perspective view in a state where half of the platen section has been removed from the perspective view of FIG. 3.

FIG. 7A is a plan view of a shutter sheet.

FIG. 7B is a plan view of a modified example of the shutter sheet.

FIG. 7C is a plan view of another modified example of the shutter sheet.

FIG. 8A is a perspective view when a recording sheet enters into the platen section.

FIG. 8B is a perspective view when the recording sheet has entered about 40 percent of the width in a sub-scanning direction of the platen section into the platen section.

FIG. 8C is a perspective view when the recording sheet has entered up to the entire area in the sub-scanning direction of the platen section.

FIG. 8D is a perspective view in a state where the recording sheet is further transported, so that a line E of a back end of the recording sheet and a line F connecting outer circumferences on the upstream side in a transport direction of exposure opening portions approximately correspond with each other when viewing from the direction vertical to the recording sheet.

FIG. 8E is a perspective view in a state where the back end of the recording sheet has reached up to about 60 percent of the width in the sub-scanning direction of the platen section.

FIG. 8F is a perspective view in a state where the recording sheet has escaped from the platen section.

FIG. 9A is a conceptual diagram showing a state where a line C and a line D correspond with each other, so that an air current is generated.

FIG. 9B is a conceptual diagram showing a state where the line D is shifted with respect to the line C to the upstream side in the recording sheet transport direction by a distance equal to or more than the diameters of a suction opening and a duct opening portion, so that an air current is not leaked onto the platen plate.

FIG. 9C is a conceptual diagram showing a state where the line E is shifted with respect to the line F to the downstream side in the recording sheet transport direction by a distance equal to or more than the diameters of the suction opening and the duct opening portion, so that an air current is not leaked onto the platen plate.

FIG. 10 is a perspective view of an example in which four suction units and four shutter mechanisms are arranged in series in a main scanning direction.

FIG. 11 is a drawing showing the shutter mechanism viewed from the main scanning direction.

FIG. 12 is a perspective view of the platen section, the suction unit, the shutter mechanism, and a capping section.

FIG. 13 is a vertical cross-sectional view of the recording section, the platen section, the suction unit, the shutter mechanism, and the capping section.

### DESCRIPTION OF THE PREFERRED EMBODIMENTS

Hereinafter, a line type ink jet printer apparatus will be described with reference to the drawings. In addition, application examples are described according to the following order.

(1) Overall Explanation of Recording Apparatus

(2) Explanation of Platen Section

(3) Explanation of Recording Section

(4) Explanation of Suction Unit

(5) Explanation of Shutter Mechanism

(6) Explanation of Shutter Sheet Movement Mechanism

(7) Explanation of Capping Section

(8) Explanation of Moisturizing Liquid Supply Section

(9) Modified Example

### (1) Overall Explanation of Recording Apparatus

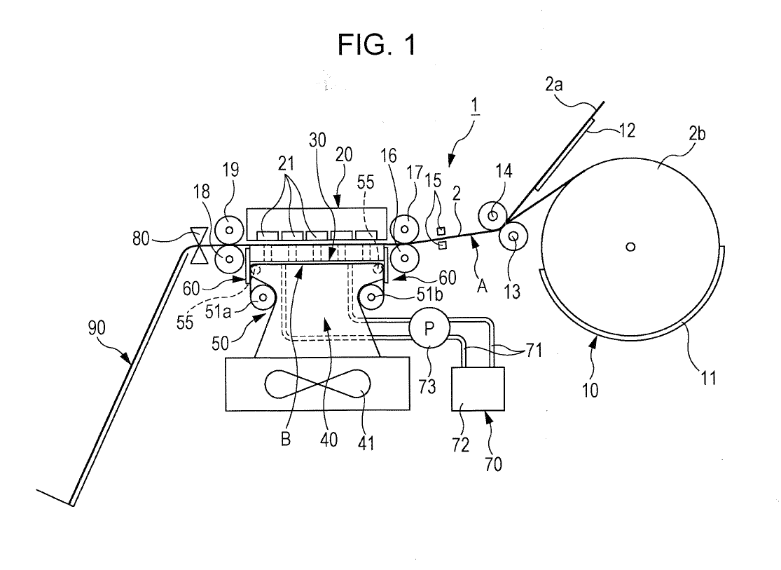

FIG. 1 is a cross-sectional view of a line type ink jet printer apparatus 1 (hereinafter also simply referred to as a printer apparatus 1) to which the invention is applied. In FIG. 1, the printer apparatus 1 is provided with a paper feed section 10 for feeding a cut sheet 2a or a roll paper 2b, and a recording section 20 which records an image on the recording sheet 2, which is the fed cut sheet 2a or the roll paper 2b, while transporting the recording sheet 2. Also, the printer apparatus 1 is provided with a platen section 30 for guiding the recording sheet 2, a suction unit 40 which generates suction power for sucking and holding the recording sheet 2, and a shutter mechanism 50 which appropriately cuts off transmission of the suction power generated by the suction unit 40 to the platen section 30, wherein the platen section, the suction unit, and the shutter mechanism are provided to face the recording section 20. Further, the printer apparatus 1 is provided with a capping section 60 which increases a sealing property of a space portion between a recording head face of the recording section 20 and a platen face of the platen section 30, and a moisturizing liquid supply section 70 which supplies moisturizing liquid which makes the space portion with the sealing property increased by the capping section 60 be in a moist state. Further, the printer apparatus 1 is provided with a cutter section 80 for cutting the roll paper 2b, and a paper discharge section 90 which houses the discharged recording sheet 2.

Here, a symbol A in FIG. 1 indicates a transport path of the recording sheet 2 and B indicates a traveling path of a shutter sheet for performing opening and closing of suction openings which will be described later.

Next, a sequence of operations from paper feed to paper discharge will be described. The recording sheet 2 which is the roll paper 2b or the cut sheet 2a is fed from a roll paper feed tray 11 in which the roll paper 2b is loaded or a cut sheet feed tray 12 which sets the cut sheet 2a at a predetermined position in a width direction, by a paper feed roller 13 and a paper feed pinch roller 14. The paper feed roller 13 is driven by a driving motor. Then, the capping section 60 is lowered (FIG. 1 shows a state where the capping section 60 is lowered), so that the transport path A of the recording sheet 2 is opened between the recording section 20 and the platen section 30. Then, a suction fan 41 of the suction unit 40 is rotated.

If the recording sheet 2 passes an edge sensor 15 which detects a leading end and a back end of the fed recording sheet 2, and then reaches a transport roller 16 and a pinch roller 17, the recording sheet is transported between the recording section 20 and the platen section 30 by the transport roller 16 and the pinch roller 17. Then, the recording sheet 2 is sucked and stuck to the platen section 30 by the suction unit 40. The transport roller 16 is driven by a driving motor. Recording by the recording section 20 is started from a point of time when the sum of a transport amount by the paper feed roller 13 since the time of detection of the leading end of the recording sheet by the edge sensor 15 and a transport amount of the transport roller 16 has reached a predetermined amount.

The recording section 20 is provided with a line type ink jet recording head 21 (hereinafter also simply referred to as a line head) having a width slightly wider than the maximum paper width (in this example, A4) of the recording sheet 2. In a nozzle formation face 20a of the line head 21, in which nozzles that discharge ink facing the recording sheet 2 are formed, a plurality of nozzle rows which respectively discharges ink of different colors is formed. In each nozzle row, electrothermal conversion elements provided in a plurality of minute discharge openings are selectively driven on the basis of image information and ink is discharged from the discharge openings by film boiling pressure generated in the ink by generation of heat.

On the transport roller 16, an encoder and an encoder sensor are mounted. The encoder sensor detects the velocity in a transport direction of the recording sheet 2 and synchronizes discharge timing of the line head 21 with the transport velocity of the recording sheet 2 on the basis of the detection information.

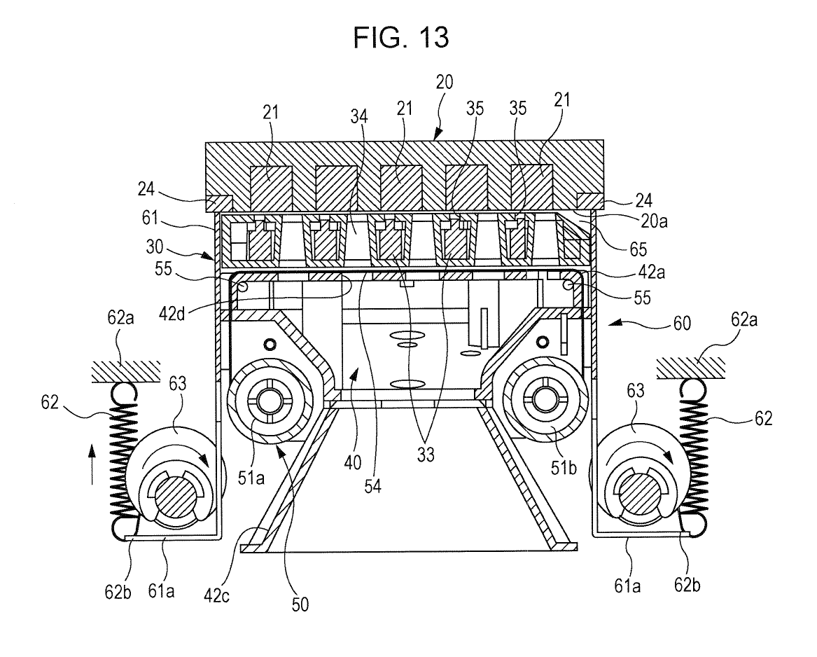

If the back end of the recording sheet 2 passes the transport roller 16 and the pinch roller 17, the recording sheet 2 is transported by a transport roller 18, which is driven in synchronization with the transport roller 16, and a pinch roller 19 which faces the transport roller 18, while being subjected to recording. If the recording is finished, the suction fan is stopped and the recording sheet is transported by the transport roller 18 and the pinch roller 19 as it is. In a case where the recording sheet 2 is the cut sheet 2a, the recording sheet is stored in the paper discharge section 90, whereas in a case where the recording sheet 2 is the roll paper 2b, the recording sheet is cut by the cutter section 80 and then stored in the paper discharge section 90. Finally, a capping member 61 of the capping section 60 is raised, thereby keeping a state where the sealing property of the space portion between the recording section 20 and the platen section 30 is increased (refer to FIG. 13).

### (2) Explanation of Platen Section

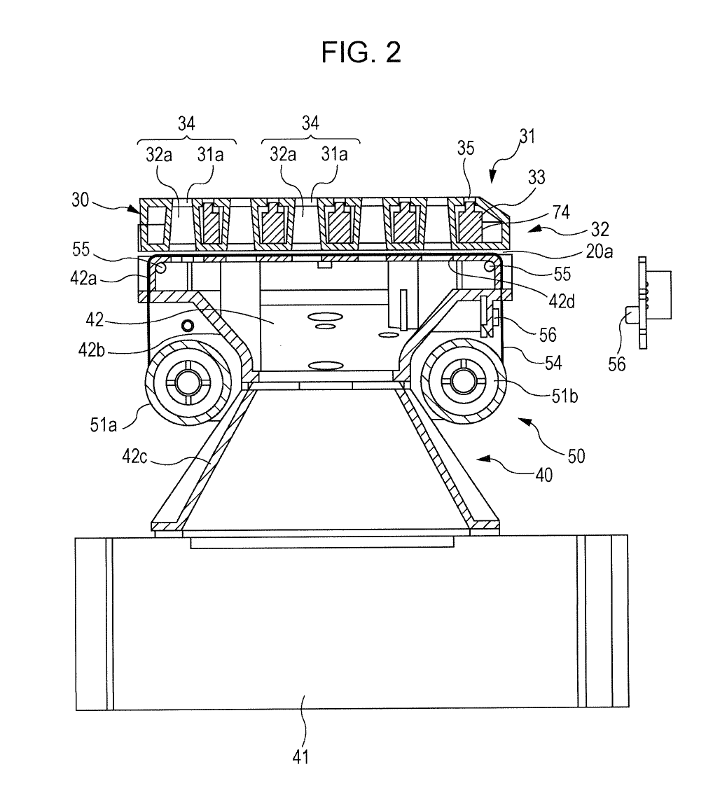

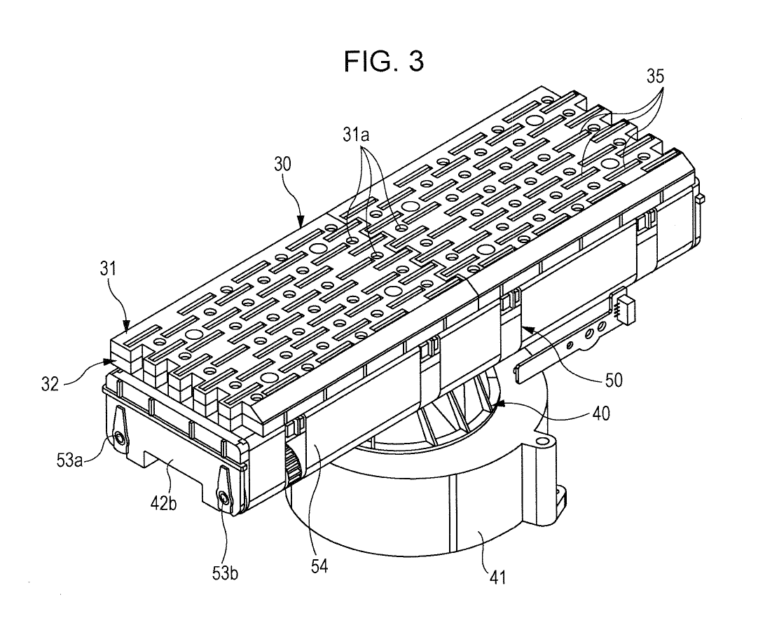

Next, details of the platen section 30, the suction unit 40, and the shutter mechanism 50 which are distinguishing sections of the invention will be described. FIG. 2 is a vertical cross-sectional view of the platen section 30, the suction unit 40, and the shutter mechanism 50 and FIG. 3 is a perspective view of the platen section 30, the suction unit 40, and the shutter mechanism 50.

The platen section 30, the suction unit 40, and the shutter mechanism 50 have widths slightly wider than an A4 size width (210 mm). The platen section 30 is constituted by a platen plate 31, an absorber box 32, and an absorber 33. In the platen plate 31, a plurality of circular holes 31a is opened.

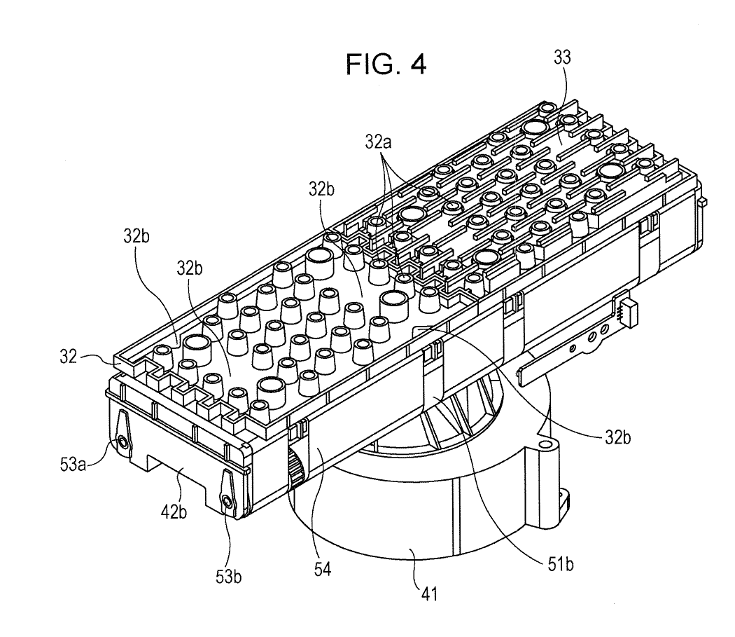

FIG. 4 is a drawing in a state where the platen plate 31 has been removed from the perspective view of FIG. 3 (the right side) and a state where the platen plate 31 and the absorber 33 have been removed from the perspective view of FIG. 3 (the left side). As shown in FIGS. 2 to 4, at the absorber box 32, tubular portions 32a are provided at approximately the same positions as a plurality of circular holes 31a of the platen plate 31 and penetrate in an up-and-down direction. The diameter of the top face of the tubular portion 32a is approximately equal to the diameter of the circular hole 31a of the platen plate 31 and the diameter of the lower face is made to be larger than the diameter of the top face. In addition, hereinafter, the circular hole 31a and the tubular portion 32a are also collectively referred to as a suction opening 34. That is, in the suction opening 34, the diameter of the lower face is made to be large because it is preferable that the diameter be thick in order to increase suction power for the recording sheet, and the top face is made to be small in order to avoid an opening portion for idle discharge, which will be described later.

### (3) Explanation of Recording Section

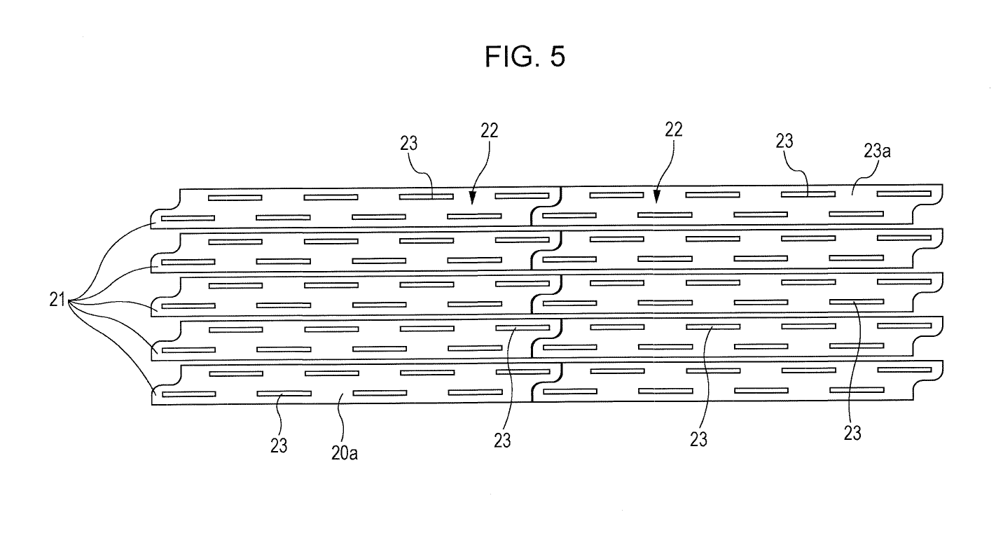

FIG. 5 is a drawing showing the line head 21 of the recording section 20 viewed from the platen section side. FIG. 5 shows a form in which two module heads 22 each having a width slightly wider than an A6 size width (105 mm) of five colors are connected in series. Each module head 22 is made into a form in which eight head chips 23 are disposed in a zigzag fashion. In the head chip 23, a plurality of minute nozzle orifice rows which discharges ink is formed. The reason why the module head 22 is formed by a plurality of small head chips 23 is because the head chip 23 is made by a semiconductor process and as many head chips 23 as possible are taken from a circular silicon wafer of six inches. The reason why the head chips are disposed in a zigzag fashion is because it is difficult to form nozzles up to the ends of the chip.

In the platen plate 31 which faces the nozzle formation face 20a of the recording section 20, as shown in FIGS. 2 to 4, a plurality of elongated rectangular opening portions for idle discharge 35 is formed at portions which are located just below the nozzles of the head chips 23. As for the material of the absorber 33, moldable resin which can absorb liquid such as ink or moisturizer is appropriate and, for example, polyolefin series hydrophilic porous sintered compact (Sunfine AQ of Asahi Kasei Corp.) may be used.

In this manner, in the platen section 30, by providing the absorbers 33 so as to face the platen surface from the opening portions for idle discharge 35, it is possible to perform idle discharge which discharges thickened ink beforehand. Also, in the platen section 30, even if ink is discharged to the portions slightly deviated from four sides of the recording sheet in no-margin printing, contamination of the surface of the platen plate 31 by ink can be prevented. Also, a certain amount of moisturizing liquid or ink can be absorbed by the absorbers 33. The position of the opening portion for idle discharge 35 is determined according to the disposition of the head chip 23. Therefore, the suction openings 34 are disposed in a zigzag fashion at the positions avoiding the opening portions for idle discharge 35.

### (4) Explanation of Suction Unit

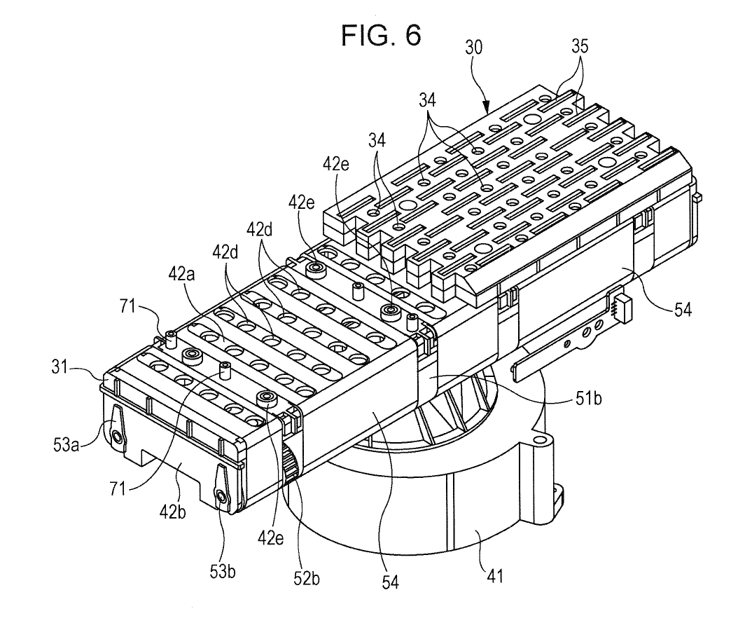

Next, the suction unit 40 will be described. As shown in FIG. 2, the suction unit 40 is located below the platen section 30 and a suction duct 42 is connected to the top of the suction fan 41 through a sealing member. The suction duct 42 is constituted by connecting an upper duct 42a, an intermediate duct 42b, and a lower duct 42c through sealing members. FIG. 6 shows a state where half of the platen section 30 has been removed from the perspective view of FIG. 3. As shown in FIGS. 2 and 6, in the upper duct 42a, a plurality of duct opening portions 42d of approximately the same diameter is opened at approximately the same positions as the circles of the lower portions of the suction openings 34 (the circles of the lower face of the tubular portions 32a of the absorber box 32). At the upper duct 42a, threaded boss holes 42e for fixing the platen section 30 are formed.

### (5) Explanation of Shutter Mechanism

Next, the shutter mechanism 50 will be described. As shown in FIGS. 2 and 6, on the intermediate duct 42b, first and second shutter rollers 51a and 51b are rotatably supported through bearings 53a and 53b. To the first and second shutter rollers 51a and 51b, a shutter sheet 54 is fixed by adhesion or the like at a front end portion and a back end portion of the sheet, respectively. The shutter sheet 54 is guided by guide rollers 55, thereby forming the traveling path indicated by B in FIG. 1. If the first shutter roller 51a rotates in the counterclockwise direction, the shutter sheet 54 is wound around the first shutter roller 51a, thereby moving in the same direction (the left direction in FIG. 1) as the recording sheet 2 over the upper surface of the upper duct 42a. At this time, the second shutter roller 51b is driven in the counterclockwise direction by approximately the same amount as the rotational amount of the first shutter roller 51a.

In the second shutter roller 51b, a compression coil spring is deflected in the axial direction of the second shutter roller 51b, thereby being pressed against the bearing 53b, whereby a moderate load in a rotational direction is applied to the second shutter roller 51b. Due to this, the shutter sheet 54 is transported without being loosened. Also, if the second shutter roller 51b rotates in the clockwise direction, the shutter sheet 54 is wound around the second shutter roller 51b, thereby moving in the direction (the right direction in FIG. 1) opposite to that of the recording sheet over the upper surface of the upper duct 42a. At this time, the first shutter roller 51a is driven in the clockwise direction by approximately the same amount as the rotational amount of the second shutter roller 51b. In the first shutter roller 51a, a compression coil spring is deflected in the axial direction of the first shutter roller 51a, thereby being pressed against the bearing 53a, whereby a moderate load in a rotational direction is applied to the first shutter roller 51a. Due to this, the shutter sheet 54 is transported without being loosened.

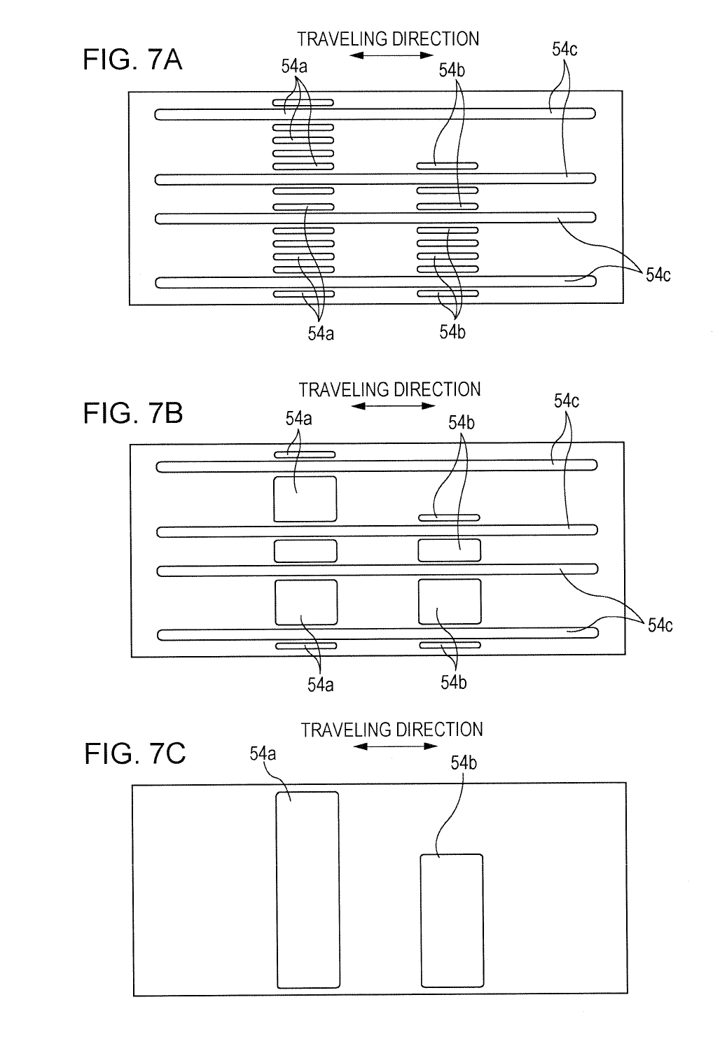

The shutter sheet 54 is made as shown in FIG. 7A. That is, in the shutter sheet 54, exposure opening portions 54a and 54b are formed which make the suction duct 42 having the duct opening portions 42d face the outside. The width in a longitudinal direction of each of a plurality of openings of the exposure opening portions 54a and 54b is set to be longer than a distance between the outer circumference on the upstream side of an opening located on the most upstream side in the transport direction of the duct opening portions 42d disposed in the transport direction of the recording sheet 2 and the outer circumference on the downstream side of an opening located on the most downstream side in the transport direction. The width in a short side direction is set to be wider than the width in a main scanning direction of the duct opening portion 42d. The shutter sheet 54 travels between the lower surface of the platen section 30 and the upper surface of the upper duct 42a. The circle of the lower surface of the suction opening 34 penetrating the platen section 30 and the duct opening portion 42d of the upper duct 42a are located at approximately the same position. Therefore, in a case where the exposure opening portions 54a and 54b of the shutter sheet 54 are located between the suction opening 34 and the duct opening portion 42d which make a pair located at approximately the same position, the suction fan 41 and the suction opening 34 communicate with each other, thereby generating negative pressure on the surface of the platen plate 31.

On the other hand, in a case where the opening of the shutter sheet 54 is not located between the suction opening 34 and the duct opening portion 42d which make a pair located at approximately the same position, communication of the suction fan 41 and the suction opening 34 is cut off, whereby negative pressure is not generated on the surface of the platen plate 31.

An exposure opening portions 54c are openings for preventing interference of the threaded boss holes 42e of the upper duct 42a, a moisturizing liquid supply tubes 71, and gears 52a and 52b for driving the first and second shutter roller 51a and 51b, which will be described later.

As the material of the shutter sheet 54, a material having a thin thickness (in the order of 10μ to 100μ), flexibility, a certain amount of strength is preferable, and a film made of resin such as polyethylene terephthalate, polypropylene, or polyimide is appropriate.

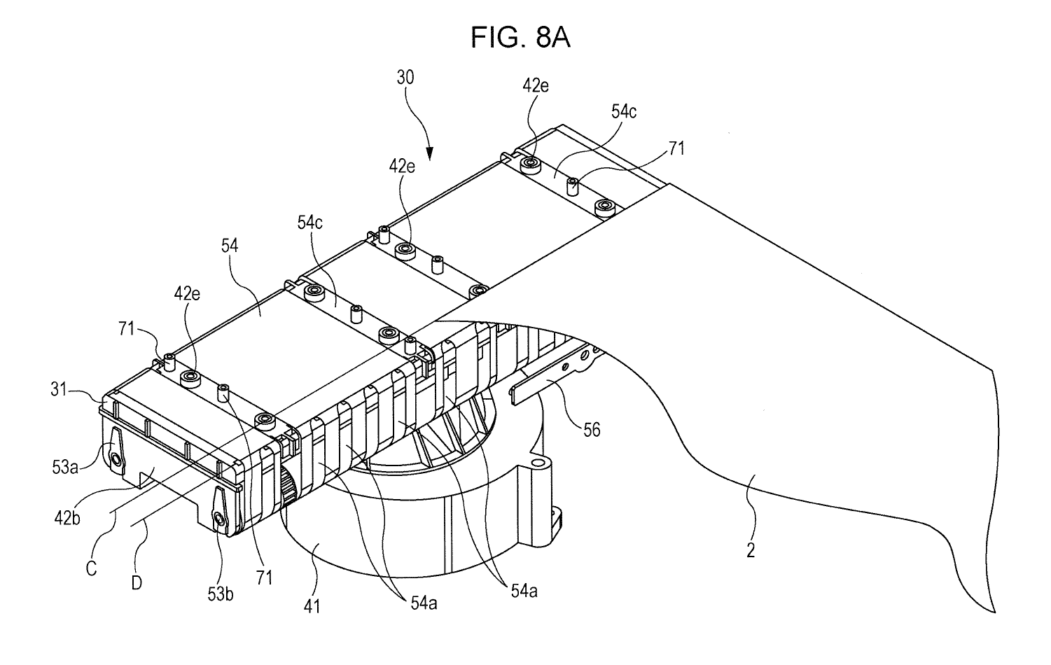

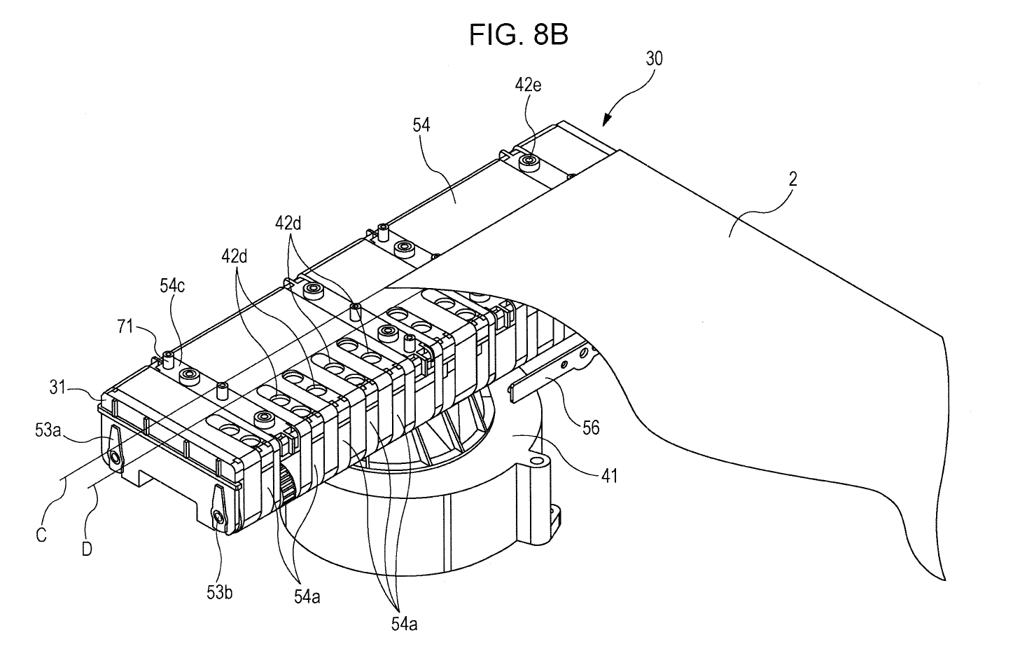

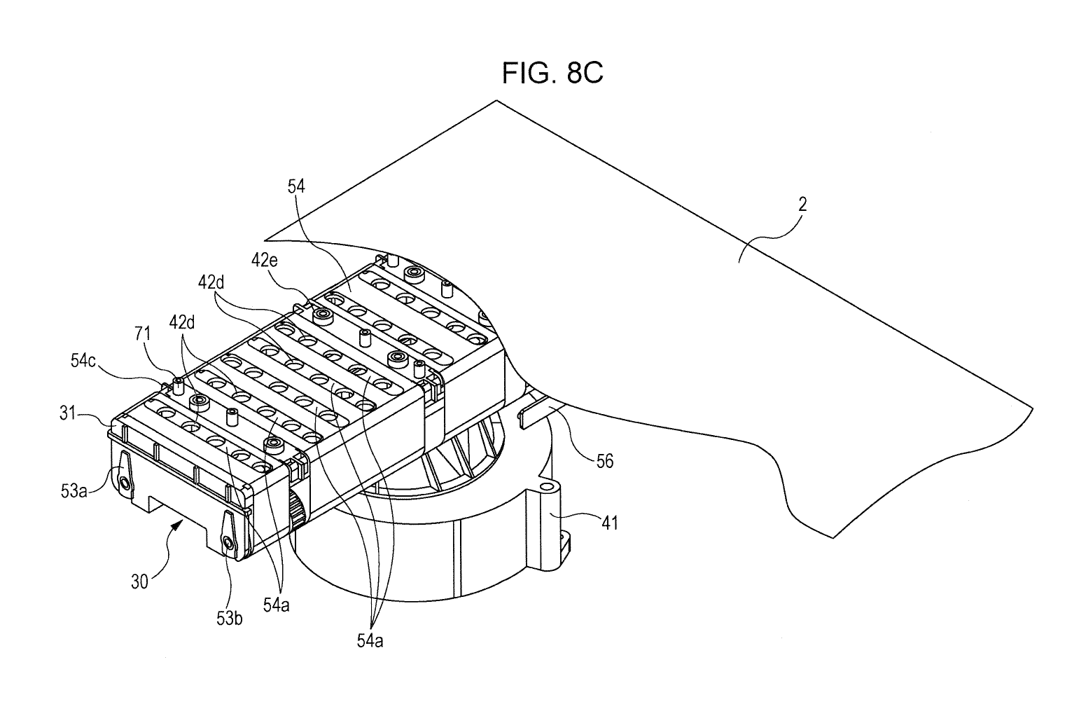

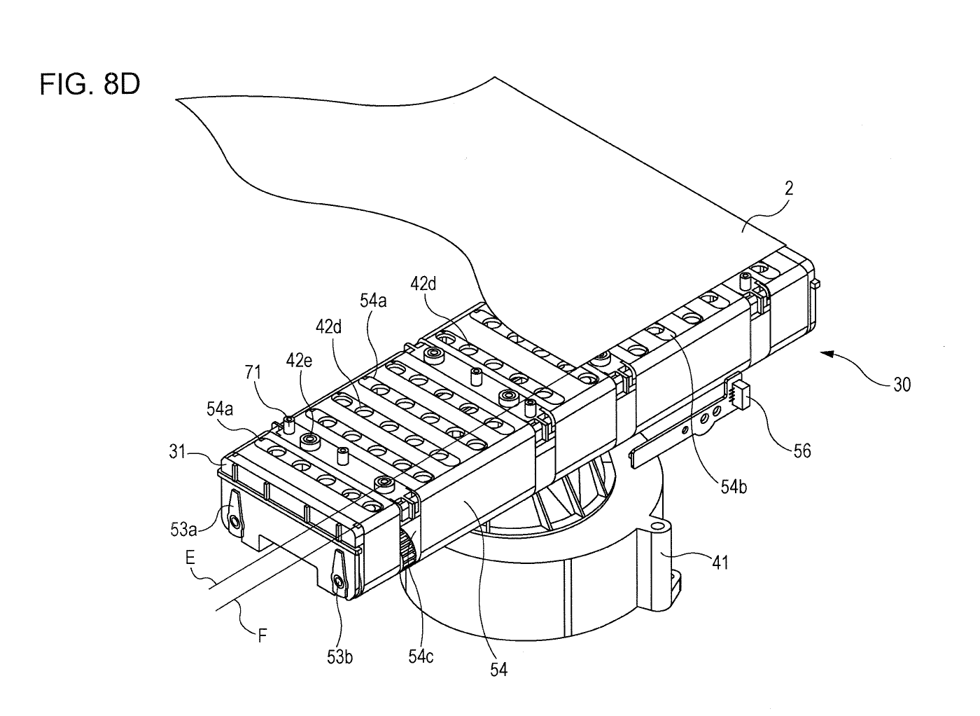

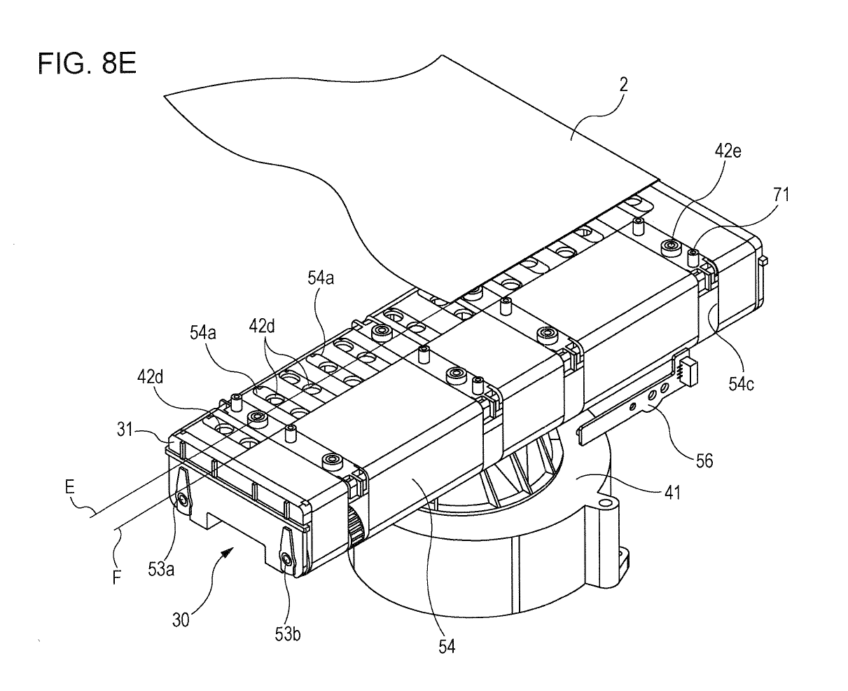

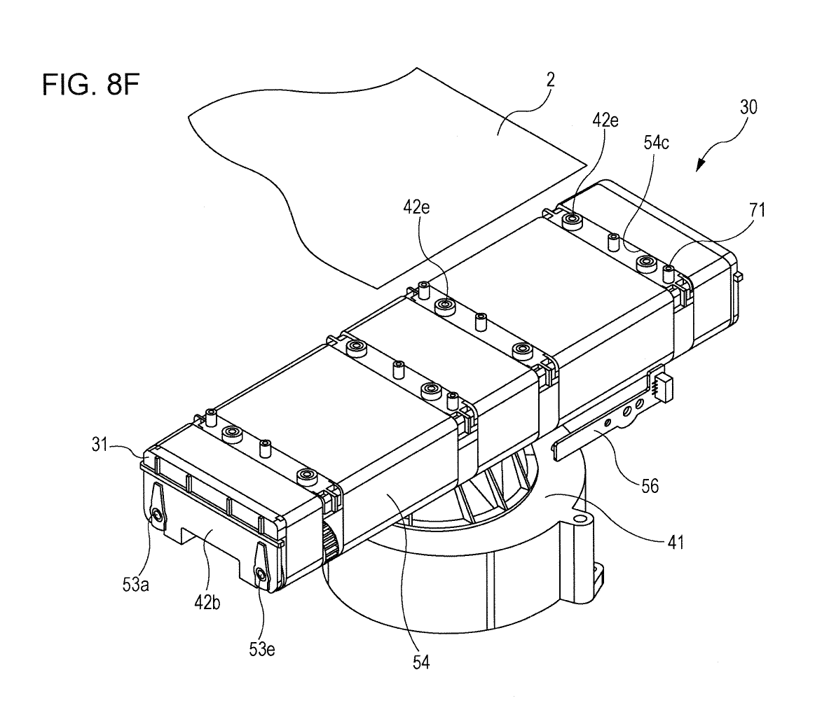

Next, movement of the shutter sheet 54 and the recording sheet 2 will be described with reference to FIGS. 8A to 8F. In addition, in FIGS. 8A to 8F, in order to make the relation between operations of the shutter sheet 54 and the recording sheet easy to understand, the platen section 30 is omitted and the recording sheet is shown with a portion cut out.

FIG. 8A is a drawing when the recording sheet 2 enters into the platen section 30. A line C of the leading end of the recording sheet 2 and a line D connecting the outer circumferences on the downstream side in the transport direction of the exposure opening portions 54a of the shutter sheet 54 are located at positions approximately corresponding with each other when viewing from the direction vertical to the recording sheet 2.

In order to accomplish this, a shutter sheet position detection sensor 56 provided with a light emitting portion and a light sensing portion, as shown in FIG. 2, is used. The shutter sheet position detection sensor 56 detects a marker on the shutter sheet 54 beforehand, thereby positioning the shutter sheet 54 at a predetermined position. Then, during transportation of the recording sheet 2, it is preferable if after a predetermined time since the leading end of the recording sheet 2 was detected by the edge sensor 15, the shutter sheet 54 is moved in the transport direction of the recording sheet 2. Also after that time, in order to locate the line C and the line D at positions approximately corresponding with each other when viewing from the direction vertical to the recording sheet 2, the shutter sheet 54 is moved at the same velocity as the recording sheet 2. In FIG. 8A, the duct opening portions 42d are in a state where all of them are shielded by the shutter sheet 54. Therefore, negative pressure is not generated on the platen plate 31 of the platen section 30.

FIG. 8B is a drawing when the recording sheet 2 has entered about 40 percent of the width in a sub-scanning direction of the platen section 30 into the platen section 30. The shutter sheet 54 is moved at the same velocity as the recording sheet 2. Therefore, also in this state, the line C of the leading end of the recording sheet 2 and the line D connecting the outer circumferences on the downstream side in the transport direction of the exposure opening portions 54a of the shutter sheet 54 are located at positions approximately corresponding with each other when viewing from the direction vertical to the recording sheet. At this time, the duct opening portions 42d further on the upstream side in the recording sheet transport direction than the line D are opened by the exposure opening portions 54a. Therefore, negative pressure is generated on the platen plate 31 of the platen section 30 in the opened range. The generation range of the negative pressure corresponds with the range covered by the recording sheet 2 on the platen plate 31. Therefore, negative pressure is generated only in the range of the recording sheet 2 on the platen plate 31, and in other portions, an air current caused by the suction fan 41 is cut off by the shutter sheet 54. Therefore, on the platen plate 31, it is possible to prevent disturbance of ink discharge due to an air current occurring on the platen plate 31 having no recording sheet 2, which occurs in a case where there is no shutter mechanism 50, a reduction in negative pressure due to air leakage, generation of a noise, or the like.

FIG. 8C is a drawing when the recording sheet has entered up to the entire area in the sub-scanning direction of the platen section 30. At this time, although all the duct opening portions 42d are opened by the exposure opening portions 54a, the recording sheet 2 on the upper surface of the platen section 30 covers the entire area on the platen plate 31. Therefore, escape of air from the suction openings 34 is not generated. At this time, although the recording sheet 2 is being transported, the shutter sheet 54 is stopped. This stop position is a position transported by a predetermined amount from the predetermined position before movement of the shutter sheet 54.

FIG. 8D shows a state where the recording sheet 2 is further transported, so that a line E of the back end of the recording sheet 2 and a line F connecting the outer circumferences on the upstream side in the transport direction of the exposure opening portions 54a approximately correspond with each other when viewing from the direction vertical to the recording sheet 2. From this time, the shutter sheet 54 starts to move in the transport direction of the recording sheet 2 at the same velocity as the recording sheet 2. The timing of the movement start is a point of time when the recording sheet 2 has been transported by a predetermined amount since the back end of the recording sheet 2 passed the edge sensor 15.

FIG. 8E is a drawing in a state where the back end of the recording sheet 2 has reached up to about 60 percent of the width in the sub-scanning direction of the platen section 30. Since the recording sheet 2 and the shutter sheet 54 move at the same velocity, the line E of the back end of the recording sheet 2 and the line F connecting the outer circumferences on the upstream side in the transport direction of the exposure opening portions 54a still approximately correspond with each other when viewing from the direction vertical to the recording sheet 2. At this time, the duct opening portions 42d further on the downstream side in the transport direction of the recording sheet 2 than the line E are opened by the exposure opening portions 54a. Therefore, negative pressure is generated on the upper surface of the platen section 30 in the opened range and the generation range of the negative pressure corresponds with the range covered by the recording sheet 2 on the platen plate 31. Therefore, negative pressure is generated only in the range of the recording sheet 2 on the platen plate 31. Then, in other portions, an air current by the suction fan 41 is cut off by the shutter sheet 54. Therefore, disturbance of ink discharge due to an air current occurring on the platen surface having no recording sheet 2, which has occurred in a case where there is no shutter mechanism, a reduction in negative pressure due to air leakage, generation of a noise, or the like is prevented.

In addition, in a case where the recording sheet 2 is the roll paper 2b, since the back end is not present, the shutter sheet 54 may be in the state of FIG. 8C as long as the recording sheet 2 covers the entire area on the platen plate 31.

FIG. 8F shows a state where the recording sheet 2 has escaped from the platen section 30. The shutter sheet 54 is stopped in a state where it completely covers the duct opening portions 42d. The timing of the stop is a time when the shutter sheet 54 has been transported by a predetermined amount after movement in FIG. 8D. Also in this state, the duct opening portions 42d are in a state where all of them are shielded by the shutter sheet 54.

After the recording sheet 2 has escaped from the platen section 30, driving of the suction fan 41 is stopped. Thereafter, the shutter sheet 54 is moved to an initial position. This is performed by moving the shutter sheet 54 in the opposite direction to the transport direction of the recording sheet 2 and then moving the shutter sheet by a predetermined amount after detection of a marker on the shutter sheet 54 by the shutter sheet position detection sensor 56.

In the above explanation of the operations of the shutter sheet 54 and the recording sheet 2, the line C of the leading end of the recording sheet 2 and the line D connecting the outer circumferences on the downstream side in the transport direction of the exposure opening portions 54a of the shutter sheet 54 approximately correspond with each other when viewing from the direction vertical to the recording sheet 2. However, strictly, it is more preferable that the line C and the line D be deviated from each other by a constant amount.

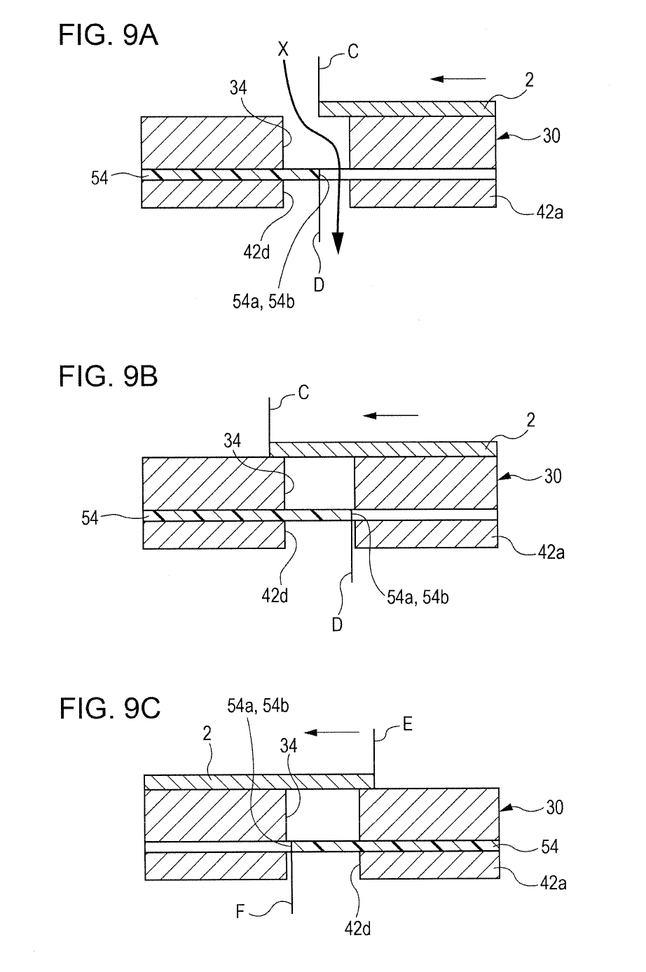

Although FIG. 9A is a case where the line C and the line D correspond with each other, an air current as indicated by an arrow X in the drawing is generated. However, as shown in FIG. 9B, an air current is not leaked onto the platen plate 31 by shifting the line D with respect to the line C to the upstream side in the transport direction of the recording sheet 2 by a distance equal to or more than the diameters of the suction opening 34 and the duct opening portion 42d.

Similarly, as shown in FIG. 9C, also with respect to the line E of the back end of the recording sheet 2 and the line F connecting the outer circumferences on the upstream side in the transport direction of the exposure opening portions 54a, the line E is shifted with respect to the line F to the downstream side in the recording sheet transport direction by a distance equal to or more than the diameters of the suction opening 34 and the duct opening portion 42d. Due to this, an air current is not leaked onto the platen plate 31.

In the above explanation, a case where the recording sheet 2 has an A4 size which is the width of the platen section 30 has been described. In the invention, in the case of the recording sheet of a size smaller than this, for example, the case of an A5 size, it is preferable if the exposure opening portion 54b shown in FIG. 7A is used and the recording sheet of an A5 width is transported at a position biased to an end on the exposure opening portion 54b side in the main scanning direction. In this case, the duct opening portions 42d which are present at a region corresponding to a difference between different sizes are shielded by the shutter sheet 54 at all times. Therefore, it is possible to shield not only the suction openings 34 of the front and back end portions of the recording sheet 2, but also the suction openings 34 of the left and right end portions of the recording sheet 2 when the recording sheet 2 smaller than the width of the platen section 30 is transported.

In addition, an initial position of the shutter sheet 54 having the exposure opening portions corresponding to a plurality of recording sheet widths varies according to the width of the recording sheet 2 which is recorded. Movement of the initial position of the shutter sheet 54 in this case is performed as follows. Specific markers are respectively provided at the respective exposure opening portions. Then, the shutter sheet 54 is moved in the transport direction of the recording sheet 2 or the opposite direction to the transport direction according to the width of the recording sheet which is recorded, and then moved by a predetermined amount after detection of an objective marker by the shutter sheet position detection sensor 56.

Although the shutter sheet 54 of FIG. 7A is for corresponding to two types of recording sheets, in order to correspond to the widths of more (for example, about ten types of) recording sheets, it is preferable if patterns of the exposure opening portions 54a and 54b are increased in the longitudinal direction of the shutter sheet 54. Also, even if the patterns are increased in the shutter sheet 54, since the thickness of the shutter sheet 54 is thin (in the order of 10μ to 100μ) and the shutter sheet is in a state where it is wound around the first and second shutter rollers 51a and 51b, a lot of space is not occupied.

The exposure opening portions 54a and 54b of the shutter sheet 54 may be connected in the main scanning direction, as show in FIG. 7B. Also, if the shutter sheet 54 moves over a position where the threaded boss holes 42e disposed at the upper surface of the upper duct 42a, the moisturizing liquid supply tubes 71, or the gears 52a and 52b for driving the first and second shutter rollers 51a and 51b, which will be described later, do not interfere with the shutter sheet 54 (for example, in the threaded boss holes 42e or the moisturizing liquid supply tubes 71, the surfaces where the bearings 53a and 53b of the suction duct 42 are provided, and in the gears 52a and 52b, the outside of the surfaces where the bearings 53a and 53b of the suction duct 42 are provided), the exposure opening portions 54c become unnecessary. Therefore, the pattern of the exposure opening portions, as shown in FIG. 7C, is also acceptable, and a pattern in which the exposure opening portions 54c of FIGS. 7A and 7B are removed is also possible.

In addition, although in this example, the width of the platen section 30 is set to be an A4 width, it is not to be limited thereto, but an A0 width or an A1 width is also acceptable.

On the other hand, in particular, in the printer apparatus 1 in which the width of the sheet is wide, for a reduction in size of the printer apparatus 1, there is a case where it is preferable to install a plurality of small fans rather than a single large fan. Also, in the invention, by providing the patterns of the exposure opening portions corresponding to a number of paper widths, a shutter in the width direction of the recording sheet is realized. However, when the number of patterns of the exposure opening portions is increased, a possibility arises that worsens a throughput due to the time it takes to set up the shutter sheet 54 at an appropriate initial position corresponding to the sheet width when continuous recording of the recording sheets of different widths is instructed.

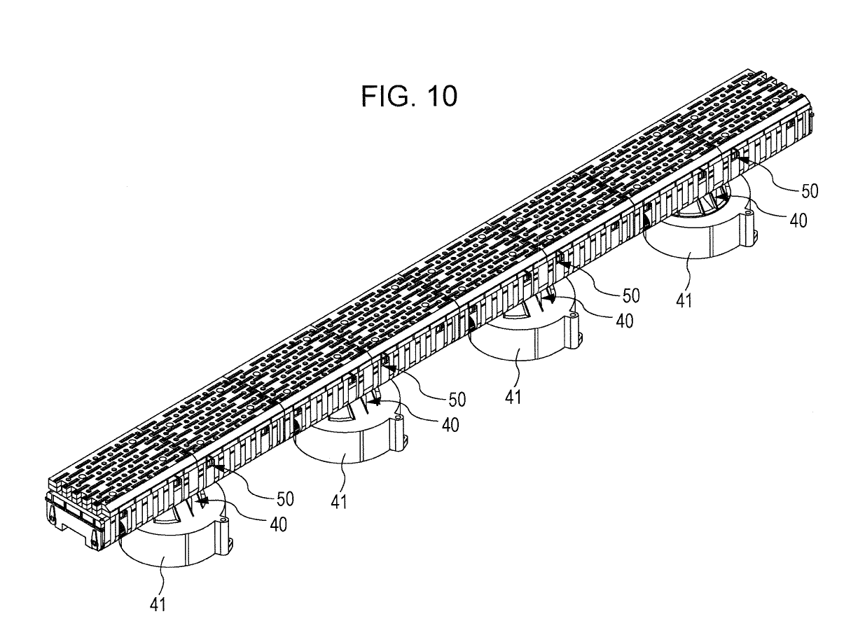

As described above, in a case where a reduction in size of the apparatus or an improvement in throughput of continuous printing of the recording sheets of different widths is demanded, for example, when the maximum width of the recording sheet width is an A0, as shown in FIG. 10, it is preferable if four combinations of the suction unit 40 and the shutter mechanism 50 for the A4 width of the above example are arranged in series in the main scanning direction. In a case where the recording sheet of the A4 width (width: 210 mm) is transported, only one suction fan 41 is driven and the exposure opening portions 54a of the shutter sheet 54 of the corresponding shutter mechanism 50 are used. In a case where the recording sheet of an A2 (width: 420 mm) is transported, the suction fans 41 of adjacent two suction units 40 are driven and the exposure opening portions 54a of the shutter sheets 54 of the shutter mechanisms 50 corresponding to the respective suction units 40 are used. In a case where the recording sheet of an A0 (width: 841 mm) is transported, the suction fans 41 of all the four suction units 40 are driven and the exposure opening portions 54a of the shutter sheets 54 of the shutter mechanisms 50 corresponding to the respective suction units 40 are used.

All the above examples are for the sheet widths which approximately correspond to multiple numbers of the A4 width. However, a case where a recording sheet of another width, for example, an A1 size (width: 594 mm), is transported is as follows. That is, the suction fans 41 of adjacent three suction units 40 are driven and adjacent two suction units of the three suction units 40 use the exposure opening portions 54a of the shutter sheets 54 of the corresponding shutter mechanisms 50. Then, the remaining one suction unit uses the exposure opening portions having no opening of about 36 mm (=210 mm×3-594 mm) width of the shutter sheet 54 of the corresponding shutter mechanism 50. In this manner, by installing a plurality of suction units 40 and (or) a plurality of shutter mechanisms 50, a number of patterns of the exposure opening portions may not be provided in one shutter sheet 54.

In addition, although in the above example, the suction unit 40 and the shutter mechanism 50 are made in an A4 width unit, for example, a combination in which the suction unit 40 is made in an A2 unit and is two pieces and the shutter mechanism 50 is made in an A4 unit and is four pieces is also possible. That is, the widths of the suction unit 40 and the shutter mechanism 50 do not have to correspond with each other and the appropriate respective widths may be appropriately selected according to the specifications of a recording apparatus demanded.

### (6) Explanation of Shutter Sheet Movement Mechanism

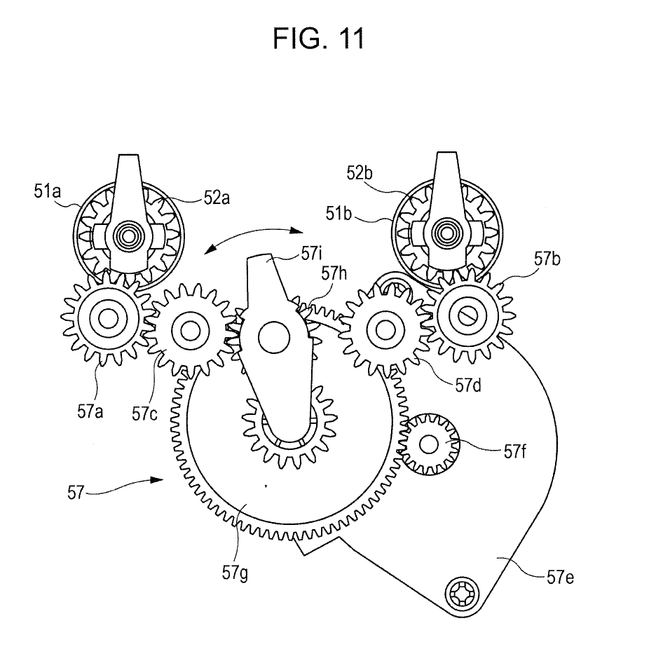

Next, a movement mechanism of the shutter sheet 54 will be described. As shown in FIGS. 2, 6, and 11, the gears 52a and 52b are respectively fixed to the first and second shutter rollers 51a and 51b. If the gear 52a (the first shutter roller 51a) rotates in the counterclockwise direction, the shutter sheet 54 moves in the transport direction of the recording sheet 2, and if the gear 52b (the second shutter roller 51b) rotates in the clockwise direction, the shutter sheet 54 moves in the opposite direction to the transport direction of the recording sheet 2. FIG. 11 is a drawing showing the shutter mechanism 50 when viewing from the main scanning direction.

To the first shutter roller 51a, the gear 52a is concentrically fixed, and to the shutter roller 51b, the gear 52b is concentrically fixed. The gear 52a is engaged with an idler gear 57a and the idler gear 57a is engaged with an idler gear 57c. Similarly, the gear 52b is engaged with an idler gear 57b and the idler gear 57b is engaged with an idler gear 57d.

On the other hand, a motor gear 57f is fixed to a rotary shaft of a stepping motor 57e and engaged with a reduction gear 57g. The reduction gear 57g is constituted by a large gear and a small gear which are integrated with each other, and the small gear is engaged with a pendulum gear 57h. A pendulum 57i is oscillated around the central axis of the reduction gear 57g and engaged with the idler gear 57c or the idler gear 57d according to an oscillation direction. If the stepping motor 57e is driven in the clockwise direction, the reduction gear 57g rotates in the counterclockwise direction and the pendulum 57i is oscillated in the counterclockwise direction, so that the pendulum gear 57h is engaged with the idler gear 57c. Then, the pendulum gear 57h is rotated in the clockwise direction, so that subsequent connection is made. The idler gear 57c, the idler gear 57a, and the gear 52a are rotated in the counterclockwise direction, the clockwise direction, and the counterclockwise direction, respectively, and the first shutter roller 51a to which the gear 52a is fixed is rotated in the counterclockwise direction.

Also, if the stepping motor 57e is driven in the counterclockwise direction, the reduction gear 57g rotates in the clockwise direction and the pendulum 57i is oscillated in the clockwise direction, so that the pendulum gear 57h is engaged with the idler gear 57d. Then, the pendulum gear 57h is rotated in the counterclockwise direction, so that subsequent connection is made. The idler gear 57d, the idler gear 57b, and the gear 52b are rotated in the clockwise direction, the counterclockwise direction, and the clockwise direction, respectively, and the shutter roller 51b to which the gear 52b is fixed is rotated in the clockwise direction.

As described above, driving of the first shutter roller 51a and the second shutter roller 51b can be changed over by changing a rotational direction of the stepping motor 57e, so that a moving direction of the shutter sheet 54 can be controlled.

### (7) Explanation of Capping Section

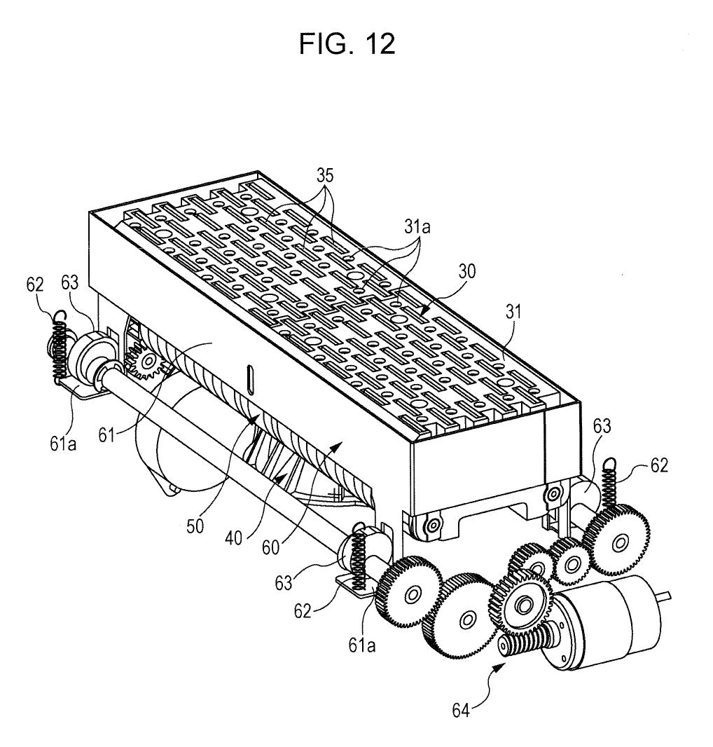

Next, the capping section 60 will be described using FIGS. 12 and 13. FIG. 12 is a perspective view of the platen section 30, the suction unit 40, the shutter mechanism 50, and the capping section 60. FIG. 13 is a vertical cross-sectional view of the recording section 20, the platen section 30, the suction unit 40, the shutter mechanism 50, and the capping section 60.

The capping member 61 is made into a frame shape which surrounds the platen section 30, and has cam followers 61a at one side surface portion. In FIGS. 12 and 13, the capping member 61 is lifted by tension coil springs 62 each being an elastic member. The tension coil spring 62 is locked at one end to a fixed end 62a such as a frame of the printer apparatus 1 and at the other end to a locking portion 62b of the cam follower 61a of the capping member 61. In a state where the capping member 61 is lifted, if cams 63 each having an eccentric shaft are each rotated 180 degrees by a capping frame driving section 64 which is constituted by a motor or a plurality of gears, the cam followers 61a of the capping member 61 are pushed by the cams 63, so that the capping member 61 is depressed against the forces of the tension coil springs 62. An up-and-down position of the capping member 61 is determined by sensors. Then, as shown in FIG. 2, a gap is formed between the platen plate 31 of the platen section 30 and the line head 21 of the recording section 20, so that the transport path A of the recording sheet 2 is formed.

When printing is not performed, a state as shown in FIG. 13 is maintained. That is, when the capping member 61 is lifted by the tension coil springs 62, a hermetically-sealed space portion 65 is formed by the nozzle formation face 20a of the recording section 20 and the upper surface of the platen plate 31 of the platen section 30. In the recording section 20, a sealing member 24 made using a foam material having rich elasticity is provided on a surface receiving the capping member 61, so that a sealing property can be maintained even if flatness of a contact surface of the capping member 61 with the sealing member 24 is somewhat poor. At this time, by creating a state as shown in FIG. 8F, communication of the suction openings 34 and the duct opening portions 42d is blocked by the shutter sheet 54, so that inflow of air from the suction unit 40, which is connected to external air, to the upper surface of the platen section 30 can be prevented.

### (8) Explanation of Moisturizing Liquid Supply Section

Next, the moisturizing liquid supply section 70 will be described with reference to FIG. 1. Moisturizing liquid stored in a moisturizing liquid storage section 72 is fed into the absorbers 33 in the platen section 30 through the moisturizing liquid supply tubes 71 by driving a moisturizing liquid supply pump 73. The moisturizing liquid supply tubes 71 are connected to communication holes 32b of the absorber box 32 of FIG. 4, and the moisturizing liquid flows in from the communication holes 32b, thereby being soaked into the absorbers 33. A space portion 74 in which the absorbers 33 are provided is hermetically sealed except for a connection place (the communication hole 32b) with the moisturizing liquid supply tube 71 and the opening portion for idle discharge 35. For example, at the space portion 74, in which the absorbers 33 are disposed, in the platen section 30, a moisture sensor such as a liquid level detection sensor or a humidity sensor is disposed. The moisture sensor acts to feed the moisturizing liquid into the absorber 33 until it reaches a predetermined level. Also, if the moisture sensor detects that the moisturizing liquid falls below the predetermined level, the moisturizing liquid is fed into the absorber 33 until it reaches the predetermined level. Due to this, the hermetically-sealed space portion 65 is kept in a moist state, so that thickening of ink or generation of a non-discharge nozzle can be prevented. As the moisturizing liquid, liquid having an action which dissolves ink, for example, an ink solvent with a color material component removed from ink liquid is used.

In addition, the moisture sensor may be provided at the nozzle formation face 20a of the recording section 20 or the upper surface of the platen plate 31 of the platen section 30, which constitute the hermetically-sealed space portion 65. Also due to this, the moisture sensor can detect a moist state of the hermetically-sealed space portion 65.

Supply of the moisturizing liquid to the absorber 33 is performed, for example, when the capping member 61 is lifted by the tension coil springs 62, so that the hermetically-sealed space portion 65 is formed by the nozzle formation face 20a of the recording section 20 and the upper surface of the platen plate 31 of the platen section 30, as shown in FIG. 13.

On the other hand, all or a portion of the duct opening portions 42d is opened by one of the exposure opening portions 54a and 54b of the shutter sheet 54. Then, by driving the suction fan 41 corresponding to the opened shutter sheet 54, it is possible to suck out ink mist in the vicinity of the platen and the head from the suction openings 34 to the suction duct 42. Due to this, a dedicated ink mist collection mechanism may not be used. In addition, collection of ink mist may be performed either when the hermetically-sealed space portion 65 is formed by the capping member 61 or when it is not formed. When the hermetically-sealed space portion 65 is formed, ink mist in the hermetically-sealed space portion 65 can be efficiently collected. When the hermetically-sealed space portion 65 is not formed, a wider range of ink mist can be collected.

### (9) Modified Example

In the above example, the line type ink jet printer apparatus 1 has been taken and described as an example. However, the invention can also be applied to a serial type printer apparatus in which the recording head is moved in the direction perpendicular to the transport direction of the recording sheet.

The present application contains subject matter related to that disclosed in Japanese Priority Patent Application JP 2009-298740 filed in the Japan Patent Office on Dec. 28, 2009, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

1. A recording apparatus comprising:
a recording head which performs recording onto a recording sheet on the basis of image information;
a platen section which guides the recording sheet to a position facing the recording head;
a suction unit which includes a plurality of suction openings which is provided at the platen section and sucks and holds the recording sheet, a suction duct which is provided facing the plurality of suction openings, and a suction fan which is connected to the suction duct, and sucks and holds the recording sheet on the platen section through the suction openings; and
a shutter mechanism which opens and closes the suction duct,
wherein the shutter mechanism includes a shutter sheet in which at least one exposure opening portion which corresponds to the suction duct and exposes the suction duct is formed corresponding to a width of the recording sheet, and a shutter sheet movement mechanism which makes the shutter sheet travel between the suction duct and a back surface of the platen section, and
when the recording sheet is transported over the platen section, the exposure opening portion of the shutter sheet sequentially opens the suction duct and the suction openings according to a position of a leading end of the recording sheet and the exposure opening portion of the shutter sheet sequentially closes the suction duct and the suction openings according to a position of a back end of the recording sheet.

2. The recording apparatus according to claim 1, wherein in the shutter sheet, the exposure opening portion is formed in a plurality corresponding to a plurality of recording sheet widths.

3. The recording apparatus according to claim 1, wherein
in the shutter sheet movement mechanism, a front end portion of the shutter sheet is fixed to a first shutter roller and a back end portion of the shutter sheet is fixed to a second shutter roller, and
when the recording sheet is transported over the platen section, according to positions of a leading end portion and a back end portion of the recording sheet, any one of the first shutter roller and the second shutter roller rotates.

4. The recording apparatus according to claim 1, wherein a plurality of the suction units and a plurality of the shutter mechanisms are connected in series in a width direction of the recording sheet, and the suction fans are selectively operated according to the width of the recording sheet.

5. A line type liquid discharge recording apparatus comprising:
a line type liquid droplet discharge head in which nozzles discharging given liquid as liquid droplets are formed over approximately the maximum width of a recording sheet;
a platen section which guides the recording sheet to a position facing the line type liquid droplet discharge head;
a suction unit which includes a plurality of suction openings which is provided at the platen section and sucks and holds the recording sheet, a suction duct which is provided facing the plurality of suction openings, and a suction fan which is connected to the suction duct, and sucks and holds the recording sheet on the platen section through the suction openings; and
a shutter mechanism which opens and closes the suction openings,
wherein the shutter mechanism includes a shutter sheet in which at least one exposure opening portion which corresponds to the suction duct and exposes the suction duct is formed corresponding to a width of the recording sheet, and a shutter sheet movement mechanism which makes the shutter sheet travel between the suction duct and a back surface of the platen section, and
when the recording sheet is transported over the platen section, the exposure opening portion of the shutter sheet sequentially opens the suction duct and the suction openings according to a position of a leading end of the recording sheet and the exposure opening portion of the shutter sheet sequentially closes the suction duct and the suction openings according to a position of a back end of the recording sheet.

6. The line type liquid discharge recording apparatus according to claim 5, wherein in the shutter sheet, the exposure opening portion is formed in a plurality corresponding to a plurality of recording sheet widths.

7. The line type liquid discharge recording apparatus according to claim 5, wherein
in the shutter sheet movement mechanism, a front end portion of the shutter sheet is fixed to a first shutter roller and a back end portion of the shutter sheet is fixed to a second shutter roller, and
when the recording sheet is transported over the platen section, according to positions of a leading end portion and a back end portion of the recording sheet, any one of the first shutter roller and the second shutter roller rotates.

8. The line type liquid discharge recording apparatus according to claim 5, wherein a plurality of the suction units and a plurality of the shutter mechanisms are connected in series in a width direction of the recording sheet, and the suction fans are selectively operated according to the width of the recording sheet.

9. The line type liquid discharge recording apparatus according to claim 5, wherein
the platen section has a space portion which holds an absorber absorbing liquid and is approximately hermetically sealed except for a surface of the platen section,
the suction openings are located at regions other than regions just below the nozzles of the line type liquid droplet discharge head, and
a platen section surface of the space portion has opening portions for idle discharge just below the nozzles of the line type liquid droplet discharge head.

10. The line type liquid discharge recording apparatus according to claim 5, further comprising:
a capping section which seals a side surface portion on the surface side of the platen section, which faces a nozzle formation face of the line type liquid droplet discharge head, in which the nozzles are formed; and
a moisturizing liquid supply section which makes the inside of a space, which is formed by the nozzle formation face of the line type liquid droplet discharge head, a surface of the platen section, and the capping section, be in a moist state,
wherein when the nozzle formation face of the line type liquid droplet discharge head and the surface of the platen section are sealed, the shutter sheet is located at a position blocking the suction duct, so that communication of the surface of the platen section and the suction duct is cut off.

11. The line type liquid discharge recording apparatus according to claim 10, wherein
in the moisturizing liquid supply section, a moisture sensor which detects a moist state is provided in a space portion which is formed by the nozzle formation face of the line type liquid droplet discharge head, the surface of the platen section, and the capping section, and
when humidity in the space portion falls below a predetermined level, moisturizing liquid is supplied from the moisturizing liquid supply section.

12. The line type liquid discharge recording apparatus according to claim 10, wherein the shutter mechanism opens at least a portion of the suction duct at the shutter sheet and the suction fan is driven, thereby sucking in liquid mist in the vicinity of the nozzle formation face of the line type liquid droplet discharge head and the surface of the platen section from the suction openings into the suction duct.
